(19) United States
(12) Patent Application Publication
(10) Pub. No.: US 2012/0109620 A1
(43) Pub. Date: May 3, 2012

(54) APPARATUS AND METHOD FOR MODEL PREDICTIVE CONTROL (MPC) USING APPROXIMATE WINDOW-BASED ESTIMATORS

(75) Inventors: Sujit V. Gaikwad, Glendale, AZ (US); Konstantinos Tskalis, Chandler, AZ (US); J. Ward MacArthur, Scottsdale, AZ (US); Sachindra K. Dash, Scottsdale, AZ (US)

(73) Assignee: Honeywell International Inc., Morristown, NJ (US)

(21) Appl. No.: 13/272,787

(22) Filed: Oct. 13, 2011

Related U.S. Application Data
(60) Provisional application No. 61/409,010, filed on Nov. 1, 2010.

(51) Int. Cl. G06F 9/455

(52) U.S. Cl. 703/21

(57) ABSTRACT

A method includes obtaining at least one measurement of one or more controlled variables associated with an industrial process. The method also includes obtaining a linearized approximation of a process model representing the industrial process. The method further includes estimating a state of the industrial process using the at least one measurement, the linearized approximation, and a window-based state estimator. The method also includes generating at least one control signal for adjusting one or more manipulated variables associated with the industrial process. Generating the at least one control signal includes using the estimated state and model predictive control (MPC) logic. In addition, the method includes outputting the at least one control signal.

### CROSS-REFERENCE TO RELATED APPLICATION AND PRIORITY CLAIM

This application claims priority under 35 U.S.C. §119(e) to U.S. Provisional Patent Application No. 61/409,010 filed on Nov. 1, 2010, which is hereby incorporated by reference.

### TECHNICAL FIELD

This disclosure relates generally to control systems. More specifically, this disclosure relates to an apparatus and method for model predictive control (MPC) using approximate window-based estimators.

### BACKGROUND

Processing facilities are often managed using process control systems. Example processing facilities include manufacturing plants, chemical plants, polymer plants, crude oil refineries, ore processing plants, and paper or pulp manufacturing and processing plants. Among other operations, process control systems typically manage the use of motors, valves, and other industrial equipment in the processing facilities.

In conventional process control systems, controllers are often used to control the operation of the industrial equipment in the processing facilities. The controllers could, for example, monitor the operation of the industrial equipment, provide control signals to the industrial equipment, and generate alarms when malfunctions are detected. Model predictive control (MPC) technology is one type of control technology that has been developed and used in conventional process control systems in recent years.

### SUMMARY

This disclosure provides an apparatus and method for model predictive control (MPC) using approximate window-based estimators.

In a first embodiment, a method includes obtaining at least one measurement of one or more controlled variables associated with an industrial process. The method also includes obtaining a linearized approximation of a process model representing the industrial process. The method further includes estimating a state of the industrial process using the at least one measurement, the linearized approximation, and a window-based state estimator. The method also includes generating at least one control signal for adjusting one or more manipulated variables associated with the industrial process. Generating the at least one control signal includes using the estimated state and model predictive control (MPC) logic. In addition, the method includes outputting the at least one control signal.

In a second embodiment, an apparatus includes at least one interface configured to receive at least one measurement of one or more controlled variables associated with an industrial process. The apparatus also includes at least one processing unit configured to obtain a linearized approximation of a process model representing the industrial process. The at least one processing unit is also configured to estimate a state of the industrial process using the at least one measurement, the linearized approximation, and a window-based state estimator. In addition, the at least one processing unit is configured to generate at least one control signal for adjusting one or more manipulated variables associated with the industrial process. The at least one processing unit is configured to generate the at least one control signal using the estimated state and model predictive control (MPC) logic.

In a third embodiment, a computer readable medium embodies a computer program. The computer program includes computer readable program code for obtaining at least one measurement of one or more controlled variables associated with an industrial process. The computer program also includes computer readable program code for obtaining a linearized approximation of a process model representing the industrial process. The computer program further includes computer readable program code for estimating a state of the industrial process using the at least one measurement, the linearized approximation, and a window-based state estimator. In addition, the computer program includes computer readable program code for generating at least one control signal for adjusting one or more manipulated variables associated with the industrial process. The computer readable program code for generating the at least one control signal includes computer readable program code for using the estimated state and model predictive control (MPC) logic.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to this disclosure;

FIG. 2 illustrates an example model predictive control (MPC) mechanism using a window-based estimator according to this disclosure; and

FIG. 3 illustrates an example method for model predictive control using an approximate window-based estimator according to this disclosure.

### DETAILED DESCRIPTION

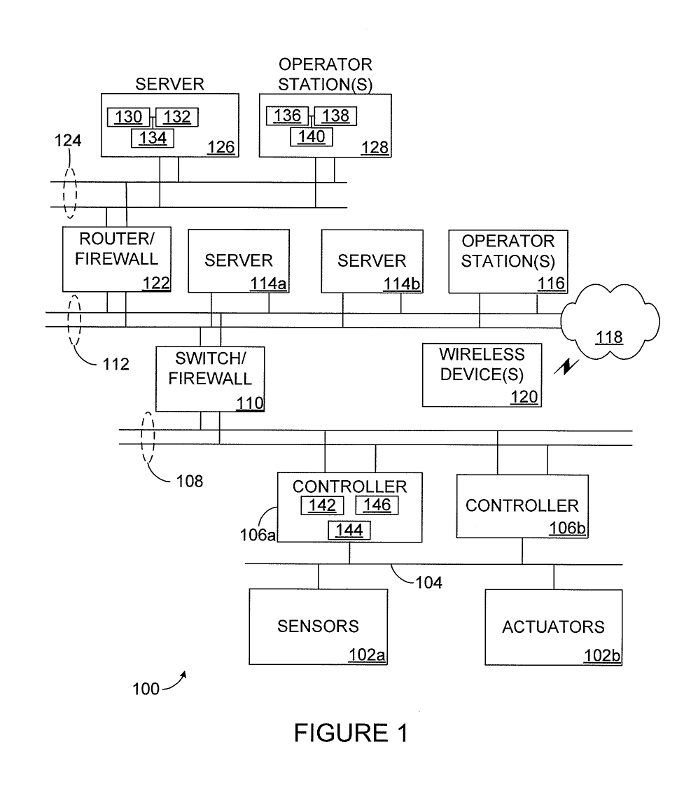

FIGS. 1 through 3, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example process control system 100 according to this disclosure. The embodiment of the process control system 100 shown in FIG. 1 is for illustration only. Other embodiments of the process control system 100 may be used without departing from the scope of this disclosure.

In this example embodiment, the process control system 100 includes various components that facilitate production or processing of at least one product or other material, such as one or more sensors 102a and one or more actuators 102b. The sensors 102a and actuators 102b represent components that may perform any of a wide variety of functions. For example, the sensors 102a may measure a wide variety of characteristics in a process system, such as temperature, pressure, or flow rate. Also, the actuators 102b may alter a wide variety of characteristics in the process system and may represent components such as heaters, motors, or valves. The sensors 102a and actuators 102b may represent any other or additional components. Each sensor 102a includes any suitable structure for measuring one or more characteristics in a process system. Each actuator 102b includes any suitable structure for operating on or affecting one or more conditions in a process system. Also, a process system generally represents any system or portion thereof configured to process one or more products or other materials in some manner.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 represents any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

Two controllers 106a-106b are coupled to the network 104. The controllers 106a-106b may, among other things, use the measurements from the sensors 102a to control the operation of the actuators 102b. For example, the controllers 106a-106b could receive measurement data from the sensors 102a and use the measurement data to generate control signals for the actuators 102b. Each controller 106a-106b includes any hardware, software, firmware, or combination thereof for interacting with the sensors 102a and controlling the actuators 102b. The controllers 106a-106b could, for example, represent controllers implementing model predictive control (MPC) technology. Moreover, the controllers 106a-106b could use the MPC technology to control a non-linear process system (or portion thereof) as described in more detail below. As a particular example, each controller 106a-106b could represent a computing device running a MICROSOFT WINDOWS operating system.

Two networks 108 are coupled to the controllers 106a-106b. The networks 108 facilitate interaction with the controllers 106a-106b, such as by transporting data to and from the controllers 106a-106b. The networks 108 represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 represent any suitable network(s), such as a pair of Ethernet networks or an FTE network.

Two servers 114a-114b are coupled to the networks 112. The servers 114a-114b perform various functions to support the operation and control of the controllers 106a-106b, sensors 102a, and actuators 102b. For example, the servers 114a-114b could log information collected or generated by the controllers 106a-106b, such as measurement data from the sensors 102a or control signals for the actuators 102b. The servers 114a-114b could also execute applications that control the operation of the controllers 106a-106b, thereby controlling the operation of the actuators 102b. In addition, the servers 114a-114b could provide secure access to the controllers 106a-106b. Each server 114a-114b includes any hardware, software, firmware, or combination thereof for providing access to, control of, or operations related to the controllers 106a-106b. Each server 114a-114b could, for example, represent a computing device running a MICROSOFT WINDOWS operating system.

One or more operator stations 116 are coupled to the networks 112. The operator stations 116 represent computing or communication devices providing user access to the servers 114a-114b, which could then provide user access to the controllers 106a-106b (and possibly the sensors 102a and actuators 102b). As particular examples, the operator stations 116 could allow users to review the operational history of the sensors 102a and actuators 102b using information collected by the controllers 106a-106b and/or the servers 114a-114b. The operator stations 116 could also allow the users to adjust the operation of the sensors 102a, actuators 102b, controllers 106a-106b, or servers 114a-114b. In addition, the operator stations 116 could receive and display warnings, alerts, or other messages or displays generated by the controllers 106a-106b or the servers 114a-114b. Each operator station 116 includes any hardware, software, firmware, or combination thereof for supporting user access and control of the system 100. Each operator station 116 could, for example, represent a computing device running a MICROSOFT WINDOWS operating system.

In this example, the system 100 also includes a wireless network 118, which can be used to facilitate communication with one or more wireless devices 120. The wireless network 118 may use any suitable technology to communicate, such as radio frequency (RF) signals. Also, the wireless devices 120 could represent devices that perform any suitable functions. The wireless devices 120 could, for example, represent wireless sensors, wireless actuators, and remote or portable operator stations or other user devices.

At least one router/firewall 122 couples the networks 112 to two networks 124. The router/firewall 122 includes any suitable structure for providing communication between networks, such as a secure router or combination router/firewall. The networks 124 represent any suitable network(s), such as a pair of Ethernet networks or an FTE network.

In this example, the system 100 includes at least one additional server 126 coupled to the networks 124. The server 126 executes various applications to control the overall operation of the system 100. For example, the system 100 could be used in a processing plant or other facility, and the server 126 could execute applications used to control the plant or other facility. As particular examples, the server 126 could execute applications such as enterprise resource planning (ERP), manufacturing execution system (MES), or any other or additional plant or process control applications. The server 126 includes any hardware, software, firmware, or combination thereof for controlling the overall operation of the system 100.

One or more operator stations 128 are coupled to the networks 124. The operator stations 128 represent computing or communication devices providing, for example, user access to the servers 114a-114b, 126. Each operator station 128 includes any hardware, software; firmware, or combination thereof for supporting user access and control of the system 100. Each operator station 128 could, for example, represent a computing device running a MICROSOFT WINDOWS operating system.

In particular embodiments, the various servers, operator stations, and controllers may represent computing devices. For example, each server 114a-114b, 126 could include one or more processing units 130 and one or more memories 132 for storing instructions and data used, generated, or collected by the processing unit(s) 130. Each server 114a-114b, 126 could also include at least one network interface 134, such as one or more Ethernet interfaces. Also, each operator station 116, 128 could include one or more processing units 136 and one or more memories 138 for storing instructions and data used, generated, or collected by the processing unit(s) 136. Each operator station 116, 128 could also include at least one network interface 140, such as one or more Ethernet interfaces. Each controller 106a-106b could include one or more processing units 142 and one or more memories 144 for storing instructions and data used, generated, or collected by the processing unit(s) 142. Each controller 106a-106b could also include at least one network interface 144, such as one or more Ethernet interfaces. The processing units here could represent microprocessors, microcontrollers, digital signal processors (DSPs), field programmable gate arrays (FPGAs), application specific integrated circuits (ASICs), or other processing or computing devices.

The process system managed and controlled by the system 100 can be a non-linear system. In the system 100, feedback control of a non-linear system is used subject to operational, modeling, and computational constraints. For example, it is often desired to apply the use of controllers to large-scale processes (such as fast breeder reactors) in order to obtain optimal operation, implement grade transitions, perform disturbance rejections, and handle model changes (such as sudden catalyst deactivation). These types of problems are often described by highly non-linear models for which traditional non-MPC controllers are difficult to obtain, implement, and maintain. In addition, these models often contain states that need to be constrained for physical or computational reasons. There is therefore a need for faster computation in order to improve controller performance, such as to improve disturbance rejections and achieve reduced interactions.

In accordance with this disclosure, MPC control logic is used in the system 100 to compute optimal control actions by iterating on model solutions. A model can be updated continuously or near-continuously online. Also, states and parameters are estimated online using approximate linearization principles with fixed or variable time step size (depending on the degree of non-linearity). The linearization approximation leads to optimization problems that are computationally fast with efficient handling of constraints. The constraints can appear at model solution, controller computation, and/or state estimation. Moreover, general disturbance models can be included in the process model, such as by handling offsets using iterative estimation of a disturbance without altering the process model (such as by appending integrators). This can help to preserve the physical interpretation of constraints, which is often important in the solution of a non-linear model.

Depending on the implementation, this approach could have the following features and benefits. Offset disturbance estimation can occur in the context of a moving horizon estimator (MHE) or other window-based estimator(s), such as recursive non-linear dynamic data reconciliation (RNDDR) or unscented RNDDR (URNDDR). The MHE implementation can use linearized approximations that allow the use of fast and reliable computation algorithms with reduced, minimal, or no degradation in solution quality. The solution can be identified quickly and may be well-behaved regardless of the exact knowledge of the disturbance model. Further, by preserving the physically-based model (no appending of integrators), the states and their constraints can preserve their original meanings, even when handling offset disturbance rejection problems. In addition, the formulation of a control and estimation problem can be consistent with traditional design techniques, which allows systematic tuning of controllers and estimators. This, in turn, yields reliable control design, resulting in time savings for testing and implementation (commissioning). An example implementation of this approach is described below.

Although FIG. 1 illustrates one example of a process control system 100, various changes may be made to FIG. 1. For example, the system 100 could include any number of sensors, actuators, controllers, servers, networks, and other components. Also, the functional division and arrangement in FIG. 1 are for illustration only. Various components in FIG. 1 could be combined, further subdivided, omitted, or rearranged and additional components could be added according to particular needs.

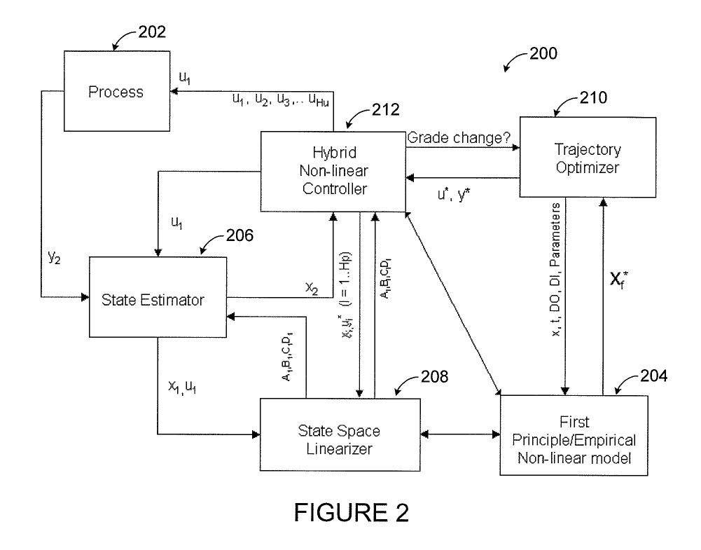

FIG. 2 illustrates an example MPC control mechanism 200 using a window-based estimator according to this disclosure. The control mechanism 200 shown in FIG. 2 could, for example, be used in the controllers 106a-106b in the system 100 of FIG. 1. However, the control mechanism 200 could be used in any other suitable device or system.

As shown in FIG. 2, the control mechanism 200 is used to control at least one process 202. The process 202 represents any suitable process to be controlled, such as a non-linear dynamic process performed by an industrial process system. The control mechanism 200 includes a process model 204, which mathematically represents the process 202. In some embodiments, the model 204 can define various controlled, manipulated, and disturbance variables associated with the process 202. A controller typically adjust's one or more manipulated-variables (MVs) in order to control one or more controlled variables (CVs). A manipulated variable is generally associated with an actuator that can be adjusted. A controlled variable generally denotes a measured variable that is controlled (through changes to one or more manipulated variables) so that the controlled variable is maintained at a specified value or within specified limits. An example of this is when an amount of a valve's opening (a manipulated variable) is used to control a temperature inside a reactor (a controlled variable). A disturbance variable generally denotes a variable that can affect a controlled variable and that can be considered but not directly adjusted, such as ambient temperature or atmospheric pressure.

The model 204 can therefore represent how the process 202 responds to changes made to actuators 102b. A controller can use sensor measurements from sensors 102a and the model 204 to determine how to adjust the process 202. The model 204 includes any suitable representation of a process 202 to be controlled, such as a model of a non-linear dynamic process. In some embodiments, the model 204 represents a first principles or empirical non-linear process model. In particular embodiments, the model 204 represents a white, gray, or black box non-linear model in state-space form in the continuous time domain. In more specific embodiments, the model 204 can be expressed as:

\dot{x}=f(x,u,d,θ)

y=g(x)

x₁≦x≦xᵤ

h(x)=0

m(x)≦0 (1)

Here, x denotes state variables, u denotes inputs (or MVs), d denotes disturbances (or DVs), θ denotes parameters, and y denotes outputs (or CVs). Also, x₁ and xᵤ denote state variable bounds, and f, g, h, and m are functions. One assumption in this particular embodiment is that non-linear differential equations may automatically satisfy algebraic constraints of the process 202, so there is no need to treat the process system as a set of differential algebraic equations (DAEs).

A state estimator 206 receives measurements of one or more characteristics of the process 202 (such as from sensors 102a) and estimates or predicts current or future states of the process 202. The state of the process 202 could represent at least one current or future value of one or more controlled variables of the process 202. This allows the control mechanism 200 to estimate the current or future states of the process 202 and to use those estimated states during control of the process 202. The state estimator 206 includes any hardware, software, firmware, or combination thereof for estimating a current or future state of a process to be controlled.

A state space linearizer 208 identifies an approximate linearization of at least a portion of the model 204. As noted above, the model 204 can represent a non-linear process, so the model 204 is non-linear in at least one operating region. The state space linearizer 208 operates to linearly approximate the regions of the model 204 that are non-linear. The state space linearizer 208 then outputs the linearized approximation of the model 204 to the state estimator 206 for use in estimating the current or future state of the process 202. The state space linearizer 208 includes any hardware, software, firmware, or combination thereof for linearly approximating at least a portion of a process model.

A trajectory optimizer 210 uses the model 204 to optimize a trajectory or future path of one or more characteristics associated with the process 202. For example, the trajectory optimizer 210 can estimate how to move a controlled variable of the process 202 from one value to another in order to achieve a desired effect, such as maximizing economic benefit or minimizing energy usage. The trajectory optimizer 210 includes any hardware, software, firmware, or combination therefore for optimizing a trajectory of a process characteristic.

A hybrid non-linear controller 212 receives inputs from components 204-210 and uses the inputs to control the process 202. For example, the controller 212 can use the inputs to generate control signals for one or more actuators 102b. Ideally, the actuators 102b are adjusted so that one or more controlled variables of the process 202 match or closely approximate the optimized trajectory or trajectories for those variables. The controller 212 includes any hardware, software, firmware, or combination thereof for controlling a process. In particular embodiments, the controller 212 represents a non-linear PROFIT controller (NLPC) from HONEYWELL INTERNATIONAL INC. However, the controller 212 could implement any other suitable logic for controlling one or more processes 202.

In accordance with this disclosure, the state estimator 206 includes a moving horizon estimator (MHE) or other window-based estimator for use in estimating the current or future state of the process 202. The window-based estimator helps to reduce or minimize model perturbations at the input and output of the controller 212 needed to explain the input/output data over a fixed rolling horizon. The window-based estimator uses a linearized approximation of the model 204 from the state space linearizer 208. Also, the window-based estimator can be expressed as a linear approximation implemented using convex optimization. An example MHE implemented using convex optimization can be expressed as:

$${min}_{{x}_{k} , {v}_{k} , {n}_{k}} {\sum }_{N - n}^{N} {V}_{k}^{T} {Qv}_{k} + {n}_{k}^{T} {Rn}_{k} + ρ {‖ {x}_{k} - {x}_{k , o} ‖}_{s}^{2} \\ {x}_{k + 1} = f ( {x}_{k} , {u}_{k} ) + {Gv}_{k} \\ {y}_{k} = h ( {x}_{k} , {u}_{k} ) + {n}_{k} \\ {x}_{k , o} = Estimate from previous iteration ( N - 1 ) \qquad ( 2 )$$

Here, k is a time index, N is the current time, M is the estimation horizon, and v and n are the state and output noises. The values of Q, R, S, p, G, and M are parameters that can be tuned for a particular use of the MHE.

Part of the design of an MHE is the definition of a state observer. Various types of state observers can be used in a state estimator 206, such as a Kalman filter or an H₂₈ filter. A typical Kalman filter observer is often designed as a copy of a process 202 with feedback from measurement error, which could be expressed as:

\dot{x}=f(x,u){circumflex over (\dot{x}=f(\hat{x},u)+L(y−ŷ)

y=h(x)ŷ=h(\hat{x}) (3)

Here, \hat{x} denotes estimated quantities. The feedback gain L is designed to stabilize the error system so that, in a deterministic setting, the state estimate converges to the actual state of the process 202. For the linear case, f( ) and h( ) are linear functions, and L is linear feedback that can be computed using Kalman filtering techniques. This type of observer is also typically good locally for a non-linear system, and this type of observer can be gain scheduled. In Kalman filtering, the system is driven by noise, and an objective is to minimize the state error variance, which can be expressed as:

\dot{x}=f(x,u,w)

T_{L}:[w,v] [symbol] (e≐x−\hat{x})

y=h(x,v) (4)

Here, T_{L} denotes the map from noises w,v to the state error and depends on the observer feedback L. The (linear) Kalman filter can minimize the H₂ norm of T_{L} and may be optimal in a Gaussian stochastic framework. For feedback purposes, more interest is placed in a different loop transfer function, which can be expressed as:

T_{L}:[w,v] [symbol] (u) (5)

The H_{∞} filter could provide a better setting for feedback, but the Kalman filter with H₂ norm may be faster and easier to update online. In particular embodiments, the H_{∞} filter can therefore be used as a guideline for selecting weights for the Kalman filter (H₂).

With this in mind, an example state observer for an MHE in the state estimator 206 can be designed as follows. A linear observer can be designed as:

{circumflex over (\dot{x}=A\hat{x}+L(m−Cₘ\hat{x})

ŷ=C_{y}\hat{x} (6)

Here, m denotes measured quantities that may or may not be the same as the controlled variables y. Furthermore, deterministic inputs (if any) can be added. The design of the feedback gain of L for a Kalman filter with H₂ norm is defined as min∥T_{ew}∥₂ and can be expressed as the solution of the so-called Filter Algebraic Riccati Equation (FARE) as follows:

AQ+QA^{T}+B_{w}S_{w}B_{w}^{T}−QCₘ^{T}Sᵥ⁻¹CₘQ=0 (=\dot{Q})

L=QCₘ^{T}Sᵥ⁻¹ (7)

Here, the model parameters Cₘ and B_{w} correspond to the transfer function of interest T_{ew}. The design of the feedback gain of L for an H_{∞} filter is defined as min∥T_{ew}∥_{∞}<g and can be expressed as the solution of a nonstandard Riccati as follows:

AQ+QA^{T}+B_{w}S_{w}B_{w}^{T}−QCₘ^{T}Sᵥ⁻¹CₘQ=0 (=\dot{Q})

L=QCₘ^{T} (8)

Here, Sᵥ and S_{w}, are colored noise covariances for the Kalman filter, which are absorbed in B_{w} in the H_{∞} approach. There is no C_{y} dependency in the Kalman filter.

The state observer is also defined in terms of how feedback control operates. Once again, various approaches can be used during observer design for feedback control. One example approach involves using linear quadratic Gaussian (LQG) control along with a Kalman filter. In this approach, B_{w}=Bᵤ (the disturbance at the plant input), and C_{y}=Cₘ, (the measured output). In a loop transfer recovery (LTR) approach, the following can be used:

B_{w}B_{w}^{T}→I+ρB_{w}B_{w}^{T}, ρ→∞ (9)

In an H_{∞} approach, the optimal input is estimated, and the operator gain is expressed as ∥T∥<g (the same g as above). In the Riccati approach, C_{y}=K (the state feedback gain), where the controller 212 is designed first, the state estimator 206 uses the controller gain K, and both use the same value of g. However, if the value of g is larger, the H₂ solution may be used.

Two other possible features can be implemented as part of the observer design for feedback control, namely constrained estimation and integrator augmentation. In constrained estimation, a state estimate can be determined based on past data and subject to one or more constraints (similar to MPC-type control operations). Alternatively, an unconstrained state estimate can be determined and then projected onto a constraint set with distance induced by a covariance matrix, preserving Lyapunov function decay. This can be expressed as:

minₓ_{ₖ}_{εM}∥xₖ−x_{k,o}∥_{z}_{^{−1}} (10)
x_{x,o}=EKF estimate
M=feasible set
Z=FARE (Aₖ, Cₖ, Q, R)
Aₖ, Cₖ=system linearization
Q,R=weights, possibly linearization dependent
   Since observers are typically concerned with obtaining an optimal estimate subject to past information, a change in an optimal feedback controller may aim to perturb a future optimal solution as little as possible.

Regarding integrator augmentation, this can be done as compensation for low-frequency disturbances. However, initial weights can lose meaning here, so integrator augmentation may be understood better in terms of loop-shaping. Also, state estimates may drift, meaning constraints would no longer be valid. The use of integrator augmentation may further necessitate the use of a controllable or observable implementation. In addition, when the state observer is designed separately from the controller 212, the integrator states may need to be discarded by the controller 212.

Consider the following example of observer design for feedback control where:

\dot{x}=Ax+Bᵤu+B_{w}w

m=Cₘx+0u+D_{mw}w

y=C_{y}x+D_{yu}u+0w=[Cₘx;u] (11)

After integrator augmentation at plant output for a minimal order controller, the following can be obtained:

$$\dot{x} = Ax + 0 z + {B}_{u} u + {B}_{w} w \\ \dot{z} = {C}_{m} x + 0 z + 0 u - Ir \\ m = {C}_{m} x + 0 u + Iv \\ y = [ \begin{matrix}{C}_{m} x + 0 z + 0 w \\ 0 x + lIz + 0 w \\ 0 x + 0 z + Iu\end{matrix} ] \qquad ( 12 )$$

Here, l determines the integral action weight, where small values produce PD-like action and large values produce more integral control actions (default could be a value of one). Alternatively, after appending with the integrator and setting the new output as z, an output matrix in a linear-quadratic regulator (LQR) objective can be expressed as:

lz+ż→Q_{LQR}=C^{T}C+(1/l²)A^{T}C^{T}CA (13)

This can be used to obtain a desired loop shape for PID tuning, such as with l=30. The final controller can be expressed as:

$$[ \begin{matrix}\dot{\hat{x}} \\ \dot{z}\end{matrix} ] = ( [ \begin{matrix}A & 0 \\ 0 & 0\end{matrix} ] - [ \begin{matrix}{B}_{u} \\ 0\end{matrix} ] K - [ \begin{matrix}L \\ 0\end{matrix} ] [ C 0 ] ) [ \begin{matrix}\hat{x} \\ z\end{matrix} ] + [ \begin{matrix}L \\ I\end{matrix} ] ( y - r ) \\ u = - K [ \begin{matrix}\hat{x} \\ z\end{matrix} ] \\ L = lqr ( {A}^{′} , {C}^{′} , ɛ I + {r}_{LTR} {B}_{u} {B}_{u}^{′} , I ) \\ K = lqr ( {A}_{aug} , {B}_{aug} , {r}_{gain} {C}_{y}^{′} {C}_{y} , I ) ; ( y = [ Cx ; z ; u ] ) \qquad ( 14 )$$

Here, the subscript “aug” denotes the expanded matrices after the augmentation, and “lqr” denotes the solution of the Algebraic Riccati Equation, with the four matrix inputs in the notation of MATLAB. Also, L and K are the resulting observer and controller gains, respectively.

Consider another example of observer design for feedback control where:

\dot{x}=Ax+Bᵤu+B_{w}w

m=Cₘx+0u+D_{mw}w

y=C_{y}x+D_{yu}u+0w=[Cₘx,u] (15)

After integrator augmentation at plant input for a general controller, the following can be obtained:

$$\dot{x} = Ax + {B}_{u} u + 0 v + [ {B}_{w} , 0 , 0 ] w \\ \dot{u} = 0 x + 0 u + Iv + [ 0 , I , 0 ] w \\ m = {C}_{m} x + 0 u + [ 0 , 0 , I ] w \\ y = [ \begin{matrix}( {C}_{m} x + 0 u + 0 v + 0 w ) l \\ {C}_{m} Ax + {C}_{m} {B}_{u} u + 0 v + 0 w \\ 0 x + 0 u + Iv + 0 w\end{matrix} ] \qquad ( 16 )$$

Here, v is the designed control, w₂ is the constant disturbance to be rejected as translated at the input, l is the integral action weight, and an output derivative is added to provide suitable tuning. The final controller can be expressed as:

$$[ \begin{matrix}\dot{\hat{x}} \\ \dot{\hat{u}}\end{matrix} ] = ( [ \begin{matrix}A & {B}_{u} \\ 0 & 0\end{matrix} ] - [ \begin{matrix}0 \\ I\end{matrix} ] K - {LC}_{aug , m} ) [ \begin{matrix}\hat{x} \\ \hat{u}\end{matrix} ] + L ( y - r ) \\ v = - K [ \begin{matrix}\hat{x} \\ \hat{u}\end{matrix} ] \\ \dot{u} = v \\ L = lqr ( {A}_{aug}^{′} , {C}_{aug , m}^{′} , ɛ I + {B}_{aug , w} {B}_{aug , w}^{′} + {r}_{LTR} {B}_{aug , u} {B}_{aug , u}^{′} , I ) \\ K = lqr ( {A}_{aug} , {B}_{aug , u} , {r}_{gain} {C}_{aug , y}^{′} {C}_{aug , y} , I ) ; ( y = [ Cx ; C \dot{x} ; u ] ) . \qquad ( 17 )$$

Here, the integrators appended to the plant now become part of the controller, output setpoints are effectively translated at the plant input, and the integrator augmentation state is estimated in the observer and not included as a measured state in the controller 212.

Once a problem has been defined (such as is done in these two examples outlined immediately above), the problem can be solved iteratively to identify reasonable values of the design parameters Q, R, and G for the MHE. In some embodiments, the Q, R, and G parameters are obtained by solving an H₂ problem until reasonable closed-loop sensitivities are obtained, and the S, ρ, and M parameters can be tuned (such as by trial and error) so that the local MHE solution matches with an H₂ controller.

In some embodiments, this problem-solving approach involves estimating a target loop bandwidth, which can be done based on various factors (such as uncertainty data or short-term non-linear variations). Reasonable disturbance and noise models can be used to design an LQR loop and a Kalman filter loop. The LQR loop can be expressed as [A-BK, B, K, 0], and the Kalman filter loop can be expressed as [A-LC, L, C, 0]. The performance of the LQR and Kalman filter loops with LTR at the input, output, or both can be evaluated, and metrics can be generated for comparison. Example metrics could include sensitivity, co-sensitivity peaks, input disturbance attenuation, command tracking, and general response shape. The metrics can be computed via simulation in which various signals are injected and the signal statistics are computed. The signals injected can depend on the statistics being computed. For instance, statistics related to dynamic response can involve the injection of frequency-rich signals, statistics related to constraints can involve the injection of large disturbances, and statistics related to non-linear effects can involve signals invoking operating point transitions. For large disturbances, the difference between perturbed versus unperturbed loops can yield an estimate of the corresponding sensitivity (such as system identification and/or performance monitoring).

In a more specific approach, an H_{∞} design for a given target loop bandwidth is obtained. An LQG design with a similar bandwidth is obtained by changing the control weight R. This could be done to help ensure that comparisons are meaningful, and R can depend on the choice of the LTR parameter. The LTR parameter could be chosen as a high or low value (in particular embodiments the integral action parameter can be fixed, such as at a value of 100). The LQG observer is then analyzed in terms of the LTR parameter by varying the observer's bandwidth. During this time, different models (integrating and non-integrating) and bandwidths (approaching right-hand plane zero limitations or not) can be examined. For a given target bandwidth, a Kalman filter and/or loop transfer recovery parameter can be adjusted to obtain a comparable performance with a good H_{∞} controller (although an H_{∞} controller may not have different g thresholds for control and observation). Note that an arbitrary LTR (high or low) is not always good. Also note that it may be desirable such as in MPC implementations to have the control bandwidth low, but this may not always be possible, so H_{∞} with some loop-shaping considerations can provide guidance. Metrics for the different parameters can be used for comparison.

Once the state observer has been defined, it can be implemented within the state estimator 206 and used to generate state estimates for the process 202. Once a state estimate has been generated using the state estimator 206, the result can be integrated into the calculations by the controller 212. In some embodiments, this can be accomplished by updating state and output biases for future predictions. For example, the controller 212 could use the following state and output biases after a state estimate is received:

v={circumflex over (\dot{x}−\hat{x} (state bias)

d=y−ŷ (output bias)

df=filtered ouput bias. (18)

A prediction by the controller 212 could then be determined as follows:

Y=S*ΔU+Ŷ_{—}nl+df (19)

where Ŷ is the prediction, S is the step response dynamic matrix (using linearized A, B, C values), and Ŷ_nl is the response of the non-linear model 204 to past inputs. States can be corrected recursively using the state biases v. If states fall outside constraints, they can be projected using observer estimates as described above. Here, ΔU can be expressed as:

ΔU=min∥[Q*S,0]−[Q*E,R]∥₂ (20)

with U and AU constraints, where:

E=Y_{REF}−Ŷ

Y_{REF}=reference

Q=weighting matrix for CVs

R=weighting matrix for MV moves. (21)

Depending on the implementation, the following features may be present. H_{∞} control can be used as a baseline and may be a better choice for observer design when a specific and tight objective needs to be met in a single pass (such as model matching). H₂ control may be simpler and could have a cleaner interpretation for observer design in an MPC implementation. While H₂ control is not necessarily a “one-pass” design, its weights could be fixed off-line for a given type of process, and all weights and design parameters (such as Q, R, W, and N) can be considered. Further, it may be noted that bad controller designs can be obtained with non-invertible plants and by pushing performance limits, so care can be taken during controller design in these situations. In addition, the definition of a good observer can be useful so that control improvements or deteriorations can be correctly assigned to non-linear/constraint effects rather than observer tuning.

By using MHE or other window-based estimator as part of the state estimation, state estimates can be generated by the state estimator 206 and then incorporated into the calculations by the controller 212. This can provide various benefits as described above, such as allowing the use of fast and reliable computation algorithms with reduced, minimal, or no degradation in solution quality.

Although FIG. 2 illustrates one example of an MPC control mechanism 200 using a window-based estimator, various changes may be made to FIG. 2. For example, the functional division and arrangement in FIG. 2 are for illustration only. Various components in FIG. 2 could be combined, further subdivided, omitted, or rearranged and additional components could be added according to particular needs. Also, the calculations and processes described above for designing and implementing a window-based estimator are specific implementations. Other techniques could be used to design or implement a window-based estimator.

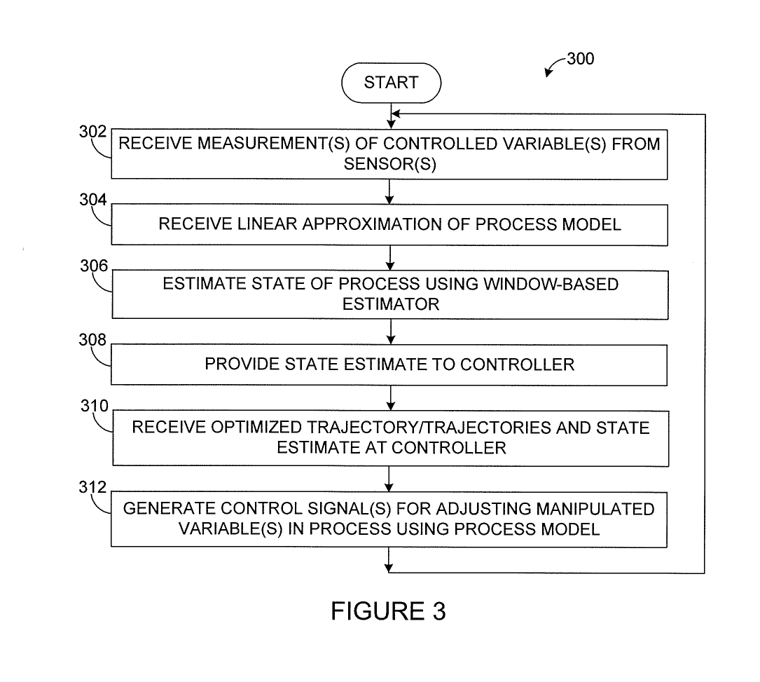

FIG. 3 illustrates an example Method 300 for model predictive control using an approximate window-based estimator according to this disclosure. As shown in FIG. 3, one or more measurements of one or more controlled variables associated with an industrial process are received at step 302. This could include, for example, the state estimator 206 receiving the measurements from one or more sensors 102a. A linear approximation of a process model is received at step 304. This could include, for example, the state space linearizer 208 approximating a non-linear process model 204 and providing the linear approximation to the state estimator 206.

A state of the industrial process is estimated using a window-based estimator at step 306. This could include, for example, the state estimator 206 using an MHE or other window-based estimator as described above. The window-based estimator uses the linear approximation of the process model 204 and the measurement(s) to estimate the state of the process 202. The estimated state is provided to a controller at step 308. This could include, for example, the state estimator 206 providing the state estimate to the controller 212.

One or more optimized trajectories and the state estimate are received at the controller at step 212. This could include, for example, the controller 212 receiving the estimated state from the state estimator 206 and the optimized trajectories from the trajectory optimizer 210. The controller generates one or more control signals for adjusting one or more manipulated variables associated with the process at step 312. This could include, for example, the controller 212 using the process model 204 and the state estimate to determine how to adjust the manipulated variable(s). This could also include the controller 212 updating state and output biases for future predictions using the state estimate.

Although FIG. 3 illustrates one example of a method 300 for model predictive control using an approximate window-based estimator, various changes may be made to FIG. 3. For example, while shown as a series of steps, various steps in FIG. 3 could overlap, occur in parallel, occur in a different order, or occur any number of times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “receive” and “communicate,” as well as derivatives thereof, encompass both direct and indirect communication. The terms “include” and “comprise,” as well as derivatives thereof, mean inclusion without limitation. The term “obtain” and its derivatives refer to any acquisition of data or other tangible or intangible item, whether acquired from an external source or internally (such as through internal generation of the item). The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining at least one measurement of one or more controlled variables associated with an industrial process;
obtaining a linearized approximation of a process model representing the industrial process;
estimating a state of the industrial process using the at least one measurement, the linearized approximation, and a window-based state estimator;
generating at least one control signal for adjusting one or more manipulated variables associated with the industrial process, wherein generating the at least one control signal comprises using the estimated state and model predictive control (MPC) logic; and
outputting the at least one control signal.

2. The method of claim 1, wherein estimating the state of the industrial process comprises performing offset disturbance estimation using the window-based estimator.

3. The method of claim 1, wherein the window-based estimator comprises a moving horizon estimator.

4. The method of claim 1, wherein the window-based estimator comprises one of: a Kalman filter and an H_{∞} filter.

5. The method of claim 1, further comprising:
defining the window-based estimator by identifying an H_{∞} filter and adjusting a Kalman filter to obtain a comparable performance with the H_{∞} filter.

6. The method of claim 1, wherein estimating the state of the industrial process comprises:
determining an unconstrained state estimate; and
projecting the unconstrained state estimate onto a constraint set.

7. The method of claim 1, wherein generating the at least one control signal comprises:
updating a state bias and an output bias of the MPC logic using the estimated state.

8. An apparatus comprising:
at least one interface configured to receive at least one measurement of one or more controlled variables associated with an industrial process; and
at least one processing unit configured to:
obtain a linearized approximation of a process model representing the industrial process;
estimate a state of the industrial process using the at least one measurement, the linearized approximation, and a window-based state estimator; and
generate at least one control signal for adjusting one or more manipulated variables associated with the industrial process, wherein the at least one processing unit is configured to generate the at least one control signal using the estimated state and model predictive control (MPC) logic.

9. The apparatus of claim 8, wherein the at least one processing unit is configured to estimate the state of the industrial process by performing offset disturbance estimation using the window-based estimator.

10. The apparatus of claim 8, wherein the window-based estimator comprises a moving horizon estimator.

11. The apparatus of claim 8, wherein the window-based estimator comprises one of: a Kalman filter and an H_{∞} filter.

12. The apparatus of claim 8, wherein the at least one processing unit is further configured to define the window-based estimator by identifying an H_{∞} filter and adjusting a Kalman filter to obtain a comparable performance with the H_{∞} filter.

13. The apparatus of claim 8, wherein the at least one processing unit is configured to estimate the state of the industrial process by:
determining an unconstrained state estimate; and
projecting the unconstrained state estimate onto a constraint set.

14. The apparatus of claim 8, wherein the at least one processing unit is configured to generate the at least one control signal by updating a state bias and an output bias of the MPC logic using the estimated state.

15. The apparatus of claim 8, wherein:
the at least one interface is configured to receive the at least one measurement from one or more sensors; and
the at least one interface is configured to output the at least one control signal to one or more actuators.

16. A computer readable medium embodying a computer program, the computer program comprising computer readable program code for:
obtaining at least one measurement of one or more controlled variables associated with an industrial process;
obtaining a linearized approximation of a process model representing the industrial process;
estimating a state of the industrial process using the at least one measurement, the linearized approximation, and a window-based state estimator; and
generating at least one control signal for adjusting one or more manipulated variables associated with the industrial process, wherein the computer readable program code for generating the at least one control signal comprises computer readable program code for using the estimated state and model predictive control (MPC) logic.

17. The computer readable medium of claim 16, wherein the computer readable program code for estimating the state of the industrial process comprises computer readable program code for performing offset disturbance estimation using the window-based estimator.

18. The computer readable medium of claim 16, wherein the window-based estimator comprises one of: a Kalman filter and an H_{∞} filter.

19. The computer readable medium of claim 16, wherein the computer program further comprises computer readable program code for:
defining the window-based estimator by identifying an H_{∞} filter and adjusting a Kalman filter to obtain a comparable performance with the H_{∞} filter.

20. The computer readable medium of claim 16, wherein the computer readable program code for estimating the state of the industrial process comprises computer readable program code for:
determining an unconstrained state estimate; and
projecting the unconstrained state estimate onto a constraint set.
